(19) United States
(12) Patent Application Publication
(10) Pub. No.: US 2012/0167020 A1
(43) Pub. Date: Jun. 28, 2012

(54) Pre-OPC Layout Editing For Improved Image Fidelity

(76) Inventors: Shady Abd El Wahed, Cairo (EG); Kang Jaehyun, Gyeonggi-do (KR)

(21) Appl. No.: 13/145,992

(22) PCT Filed: Jan. 22, 2010
(86) PCT No.: PCT/US10/21896

§ 371 Date: Mar. 12, 2012

Related U.S. Application Data
(60) Provisional application No. 61/146,532, filed on Jan. 22, 2009.

(51) Int. Cl. G06F 17/50

(52) U.S. Cl. 716/53

(57) ABSTRACT

An optical proximity correction operation is performed on a layout design, and faults created by the design are identified. If the faults occur where the optical proximity correction was constrained by a mask rule, then the layout design data is edited so that violation of the mask rule is avoided. Once the original layout design has been edited, another optical proximity correction operation is then performed on the edited layout design data. In this subsequent optical proximity correction operation, a simulated image is generated using the edited layout design data, but this simulated image is compared with the target image of the original layout design data rather than the edited layout design data.

### RELATED APPLICATIONS

This application claims priority to U.S. Provisional Patent Application No. 61/146,532, entitled “Pre-OPC Layout Decomposition for Improved Image Fidelity,” filed on Jan. 22, 2009, and naming Shady Abdelwahed et al. as inventors, which application is incorporated entirely herein by reference.

### FIELD OF THE INVENTION

The present invention is directed to techniques for editing layout design data so that a lithographic mask created from the layout design data will have improved image fidelity. Various implementations of the invention may be particularly useful for deleting area from or adding area to geometric elements in a layout design prior to performing an optical process correction operation on those geometric elements.

### BACKGROUND OF THE INVENTION

Electronic circuits, such as integrated microcircuits, are used in a variety of products, from automobiles to microwaves to personal computers. Designing and fabricating microcircuit devices typically involves many steps, sometimes referred to as the “design flow.” The particular steps of a design flow often are dependent upon the type of microcircuit, its complexity, the design team, and the microcircuit fabricator or foundry that will manufacture the microcircuit. Typically, software and hardware “tools” verify the design at various stages of the design flow by running software simulators and/or hardware emulators. These steps aid in the discovery of errors in the design, and allow the designers and engineers to correct or otherwise improve the design. These various microcircuits are often referred to as integrated circuits (IC's).

Several steps are common to most design flows. Initially, the specification for a new circuit is transformed into a logical design, sometimes referred to as a register transfer level (RTL) description of the circuit. With this logical design, the circuit is described in terms of both the exchange of signals between hardware registers and the logical operations that are performed on those signals. The logical design typically employs a Hardware Design Language (HDL), such as the Very high speed integrated circuit Hardware Design Language (VHDL). The logic of the circuit is then analyzed, to confirm that it will accurately perform the functions desired for the circuit. This analysis is sometimes referred to as “functional verification.”

After the accuracy of the logical design is confirmed, it is converted into a device design by synthesis software. The device design, which is typically in the form of a schematic or netlist, describes the specific electronic devices (such as transistors, resistors, and capacitors) that will be used in the circuit, along with their interconnections. This device design generally corresponds to the level of representation displayed in conventional circuit diagrams. The relationships between the electronic devices are then analyzed, to confirm that the circuit described by the device design will correctly perform the desired functions. This analysis is sometimes referred to as “formal verification.” Additionally, preliminary timing estimates for portions of the circuit are often made at this stage, using an assumed characteristic speed for each device, and incorporated into the verification process.

Once the components and their interconnections are established, the design is again transformed, this time into a physical design that describes specific geometric elements. This type of design often is referred to as a “layout” design. The geometric elements, which typically are polygons, define the shapes that will be created in various layers of material to manufacture the circuit. Typically, a designer will select groups of geometric elements representing circuit device components (e.g., contacts, channels, gates, etc.) and place them in a design area. These groups of geometric elements may be custom designed, selected from a library of previously-created designs, or some combination of both. Lines are then routed between the geometric elements, which will form the wiring used to interconnect the electronic devices. Layout tools (often referred to as “place and route” tools), such as Mentor Graphics' IC Station or Cadence's Virtuoso, are commonly used for both of these tasks.

IC layout descriptions can be provided in many different formats. The Graphic Data System II (GDSII) format is a popular format for transferring and archiving two-dimensional graphical IC layout data. Among other features, it contains a hierarchy of structures, each structure containing layout elements (e.g., polygons, paths or poly-lines, circles and textboxes). Other formats include an open source format named Open Access, Milkyway by Synopsys, Inc., EDDM by Mentor Graphics, Inc., and the more recent Open Artwork System Interchange Standard (OASIS) proposed by Semiconductor Equipment and Materials International (SEMI). These various industry formats are used to define the geometrical information in IC layout designs that are employed to manufacture integrated circuits.

After the layout design has been finalized, then it is converted into a format that can be employed by a mask or reticle writing tool to create a mask or reticle for use in a photolithographic manufacturing process. Most mask writing tools are able to only “write” certain kinds of polygons, however, such as right triangles, rectangles or other trapezoids. Moreover, the sizes of the polygons are limited physically by the maximum beam aperture size available to the tool. Accordingly, larger geometric elements in the layout design, or geometric elements that are not basic right triangles, rectangles or trapezoids (which typically is a majority of the geometric elements in a layout design) must be “fractured” into the smaller, more basic polygons that can be written by the mask or reticle writing tool. Once the layout design has been fractured, then the layout design data can be converted to a format compatible with the mask or reticle writing tool.

There are many different fabrication processes for manufacturing a circuit, but most processes include a series of steps that deposit layers of different materials on a substrate, expose specific portions of each layer to radiation, and then etch the exposed (or non-exposed) portions of the layer away. For example, a simple semiconductor device component could be manufactured by the following steps. First, a positive type epitaxial layer is grown on a silicon substrate through chemical vapor deposition. Next, a nitride layer is deposited over the epitaxial layer. Then specific areas of the nitride layer are exposed to radiation, and the exposed areas are etched away, leaving behind exposed areas on the epitaxial layer, (i.e., areas no longer covered by the nitride layer). The exposed areas then are subjected to a diffusion or ion implantation process, causing dopants, for example phosphorus, to enter the exposed epitaxial layer and form charged wells. This process of depositing layers of material on the substrate or subsequent material layers, and then exposing specific patterns to radiation, etching, and dopants or other diffusion materials, is repeated a number of times, allowing the different physical layers of the circuit to be manufactured.

Each time that a layer of material is exposed to radiation, a mask must be created to expose only the desired areas to the radiation, and to protect the other areas from exposure. The mask is created from circuit layout data. That is, the geometric elements described in layout design data define the relative locations or areas of the circuit device that will be exposed to radiation through the mask. A mask or reticle writing tool is used to create the mask based upon the layout design data, after which the mask can be used in a photolithographic process. The image created in the mask is often referred to as the intended or target image, while the image created on the substrate, by employing the mask in the photolithographic process is referred to as the printed image.

As designers and manufacturers continue to increase the number of circuit components in a given area and/or shrink the size of circuit components, the shapes reproduced on the substrate (and thus the shapes in the mask) become smaller and are placed closer together. This reduction in feature size increases the difficulty of faithfully reproducing the image intended by the layout design onto the substrate. Adding to the difficulty associated with increasingly smaller feature size is the diffractive effects of light. As light illuminates the mask, the transmitted light diffracts at different angles in different regions of the mask. These effects often result in defects where the intended image is not accurately “printed” onto the substrate during the photolithographic process, creating flaws in the manufactured device.

To address this problem, one or more resolution enhancement techniques are often employed to improve the resolution of the image that the mask forms on the substrate during the photolithographic process, such as the use of a phase shift mask (PSM), off-axis illumination (OAI) and a resist flow process (RFP). Examples of various resolution enhancement techniques are discussed in “Resolution Enhancement Technology: The Past, the Present, and Extensions for the Future,” Frank M. Schellenberg, Optical Microlithography XVII, edited by Bruce W. Smith, Proceedings of SPIE Vol. 5377, which article is incorporated entirely herein by reference. One of these techniques, radiation amplitude control, is often facilitated by modifying the layout design data employed to create the lithographic mask. One way to implement this technique, for example, is to adjust the edges of the geometric elements in the layout design so that the mask created from the modified layout data will control the radiation amplitude in a desired way during a lithographic process. The process of modifying the layout design data in this manner is often referred to as “optical proximity correction” or “optical process correction” (OPC).

As previously noted, a layout design is made up of a variety of geometric elements, which typically are polygons. In a conventional optical proximity correction process, the edges of these polygons are fragmented. More particularly, the individual edges of each polygon are divided into smaller sections, often referred to as edge segments or edge fragments. The size of the fragments and which particular edges are to be fragmented is dependent upon parameters of the optical proximity correction process. The fragmenting of edges facilitates the optical proximity correction process by allowing the edge segments to be rearranged or edited to realize the desired modifications. Additionally, geometric features that will increase the fidelity of the photolithographic process may be added to the design by moving or displacing the fragments. For example, some optical proximity correction processes will reconfigure the edge segments of a polygon to create serifs at one or more corners.

Optical proximity correction is an iterative process. That is, the lithographic process that will be used to manufacture the integrated circuit is simulated to determine if the simulated printed image matches the intended printed image. Modifications are made to the layout design based upon the simulation results, and the lithographic process is simulated again. When the simulated printed image cannot be substantially improved by further displacement of the edge segments, it is often said that the optical proximity correction process has converged. This process of simulation, modification, and simulation is repeated until the simulated printed image significantly corresponds to the intended printed image, or until the optical proximity correction process has converged.

As optical proximity correction techniques become increasingly aggressive, these techniques can push the dimensions of geometric elements in a layout design beyond the limits required for other operations in the manufacturing process. For example, a mask manufacturing company may define mask rules that specify minimum widths for geometric elements in a layout design. This type of limit in principle may be set for any of the steps in a mask manufacturing process, but the mask rules relating to inspection of the finished mask are frequently the most constraining. A mask inspection system must be able to quickly and reliably distinguish between a defect near a target shape and two target shapes in close proximity. In order to improve the fidelity of the prospective mask, however, an optical proximity correction operation may need to reduce the width of a geometric element in a layout design below the minimum limit specified by the mask rules, bringing it into conflict with a mask rule check (MRC) operation.

### BRIEF SUMMARY OF THE INVENTION

Aspects of the invention relate to the editing of layout design data to improve the image fidelity of a prospective mask without causing the layout design to violate a mask rule. With various implementations of the invention, an optical proximity correction operation is performed on a layout design, and faults created by the design are identified. The original layout design data is the edited, such that portions of geometric elements are deleted and/or different geometric elements are connected. With some implementations of the invention, if the faults occur where the optical proximity correction was constrained by a mask rule, then the layout design data is edited so that violation of the mask rule is avoided. For example, if the optical proximity correction was constrained by a mask rule specifying a minimum internal width for a geometric element, then portions of the geometric element corresponding to that constraint are deleted. Similarly, if the optical proximity correction was constrained by a mask rule specifying a minimum external spacing distance from another geometric element, then area is added to the geometric element corresponding to that constraint.

Once the original layout design has been edited, another optical proximity correction operation can then be performed on the edited layout design data. In this subsequent optical proximity correction operation, a simulated image is generated using the edited layout design data, but this simulated image is compared with the target image of the original layout design data rather than the edited layout design data. This prevents the subsequent optical proximity correction operation from undoing the improved optical effects provided by the edits to the original layout design data.

### BRIEF DESCRIPTION OF THE DRAWINGS

FIGS. 1 and 2 illustrate computing environments that may be used to implement various embodiments of the invention.

FIGS. 3A-4D illustrate various stages in an optical proximity correction process that may be employed according to various embodiments of the invention.

FIG. 5 illustrates an example of a pre-optical proximity correction layout editing tool 501 that may be implemented according to various embodiments of the invention.

FIG. 6 illustrates a flowchart describing methods of editing layout design data according to various embodiments of the invention.

FIGS. 7A-7C illustrate an example of results that might be generated by an optical proximity correction process.

FIG. 8 illustrates a cross section of a mask portion corresponding to the target geometric element along the cut line B shown in FIG. 7C.

FIGS. 9A-9C then illustrate the amount of light incident on a substrate along section lines A, B, and C shown in FIG. 7C, respectively.

FIG. 10 illustrates a cross section of a mask portion corresponding to the edited geometric element along the cut line B shown in FIG. 7C.

FIGS. 11A-11C illustrate the amount of light incident on a substrate along section lines A, B, and C, respectively, with the gap shown in FIG. 10.

FIG. 12 illustrates a cross section of a mask portion corresponding to the further edited geometric element along the cut line B shown in FIG. 7C.

FIGS. 13A-13C illustrate the amount of light incident on a substrate along section lines A, B, and C, respectively, with the multiple gaps shown in FIG. 12.

FIG. 14A illustrates an original geometric element.

FIG. 14B illustrates an edited geometric element that may be produced after the original geometric element shown in FIG. 14A has been edited according to various embodiments of the invention.

FIG. 15 illustrates layout design data corresponding to the original layout design data example shown in FIG. 7.

FIG. 16 illustrates the target image shown in FIG. 7 and the image produced by editing a processing layout design data correspond to FIG. 7 according to various embodiments of the invention.

### DETAILED DESCRIPTION OF THE INVENTION

### Illustrative Operating Environment

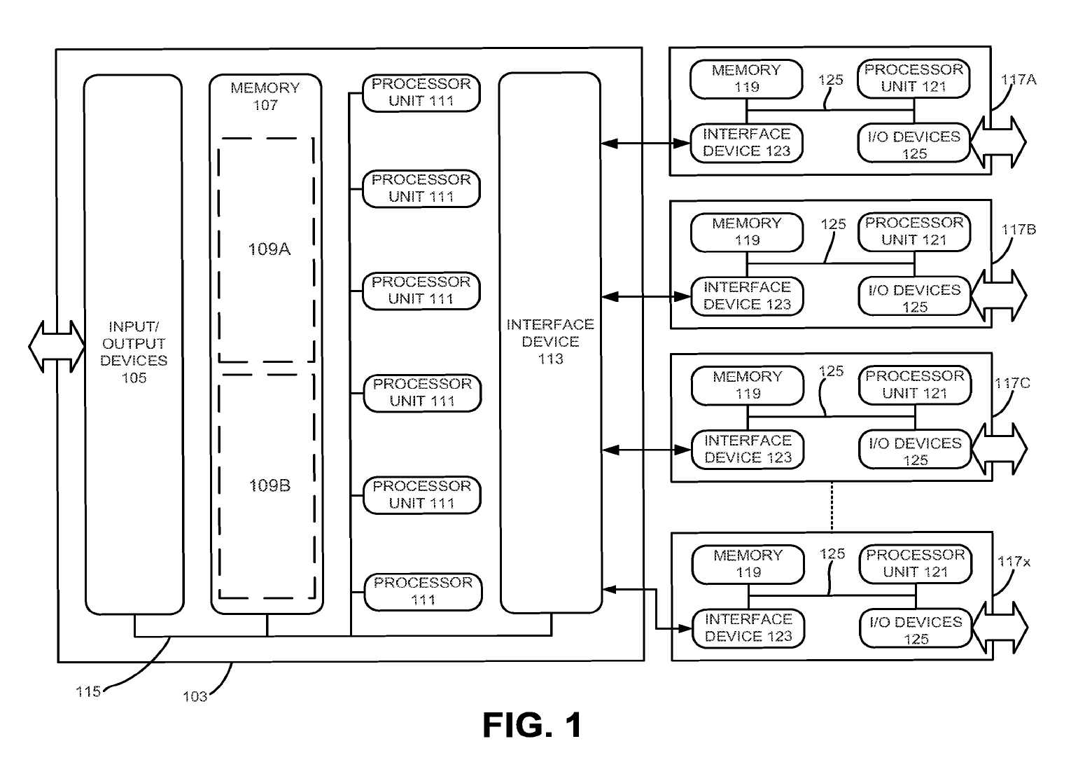

The execution of various electronic design automation processes according to embodiments of the invention may be implemented using computer-executable software instructions executed by one or more programmable computing devices. Because these embodiments of the invention may be implemented using software instructions, the components and operation of a generic programmable computer system on which various embodiments of the invention may be employed will first be described. Further, because of the complexity of some electronic design automation processes and the large size of many circuit designs, various electronic design automation tools are configured to operate on a computing system capable of simultaneously running multiple processing threads. The components and operation of a computer network having a host or master computer and one or more remote or servant computers therefore will be described with reference to FIG. 1. This operating environment is only one example of a suitable operating environment, however, and is not intended to suggest any limitation as to the scope of use or functionality of the invention.

In FIG. 1, the computer network 101 includes a master computer 103. In the illustrated example, the master computer 103 is a multi-processor computer that includes a plurality of input and output devices 105 and a memory 107. The input and output devices 105 may include any device for receiving input data from or providing output data to a user. The input devices may include, for example, a keyboard, microphone, scanner or pointing device for receiving input from a user. The output devices may then include a display monitor, speaker, printer or tactile feedback device. These devices and their connections are well known in the art, and thus will not be discussed at length here.

The memory 107 may similarly be implemented using any combination of computer readable media that can be accessed by the master computer 103. The computer readable media may include, for example, microcircuit memory devices such as read-write memory (RAM), read-only memory (ROM), electronically erasable and programmable read-only memory (EEPROM) or flash memory microcircuit devices, CD-ROM disks, digital video disks (DVD), or other optical storage devices. The computer readable media may also include magnetic cassettes, magnetic tapes, magnetic disks or other magnetic storage devices, punched media, holographic storage devices, or any other medium that can be used to store desired information.

As will be discussed in detail below, the master computer 103 runs a software application for performing one or more operations according to various examples of the invention. Accordingly, the memory 107 stores software instructions 109A that, when executed, will implement a software application for performing one or more operations. The memory 107 also stores data 109B to be used with the software application. In the illustrated embodiment, the data 109B contains process data that the software application uses to perform the operations, at least some of which may be parallel.

The master computer 103 also includes a plurality of processor units 111 and an interface device 113. The processor units 111 may be any type of processor device that can be programmed to execute the software instructions 109A, but will conventionally be a microprocessor device. For example, one or more of the processor units 111 may be a commercially generic programmable microprocessor, such as Intel® Pentium® or Xeon™ microprocessors, Advanced Micro Devices Athlon™ microprocessors or Motorola 68K/Coldfire® microprocessors. Alternately or additionally, one or more of the processor units 111 may be a custom-manufactured processor, such as a microprocessor designed to optimally perform specific types of mathematical operations. The interface device 113, the processor units 111, the memory 107 and the input/output devices 105 are connected together by a bus 115.

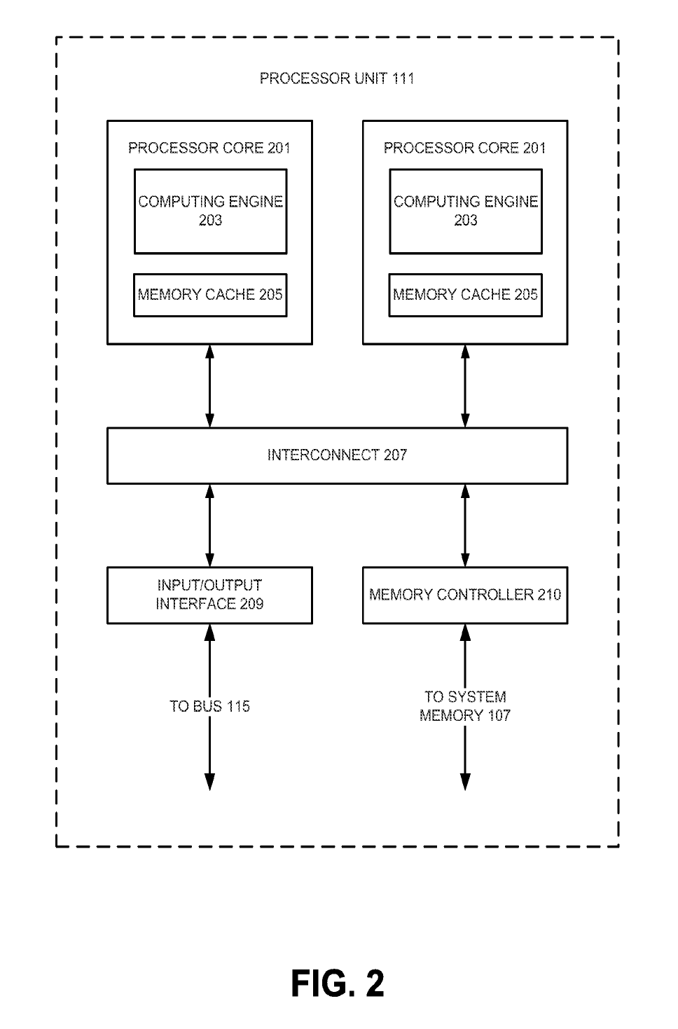

With some implementations of the invention, the master computing device 103 may employ one or more processing units 111 having more than one processor core. Accordingly, FIG. 2 illustrates an example of a multi-core processor unit 111 that may be employed with various embodiments of the invention. As seen in this figure, the processor unit 111 includes a plurality of processor cores 201. Each processor core 201 includes a computing engine 203 and a memory cache 205. As known to those of ordinary skill in the art, a computing engine contains logic devices for performing various computing functions, such as fetching software instructions and then performing the actions specified in the fetched instructions. These actions may include, for example, adding, subtracting, multiplying, and comparing numbers, performing logical operations such as AND, OR, NOR and XOR, and retrieving data. Each computing engine 203 may then use its corresponding memory cache 205 to quickly store and retrieve data and/or instructions for execution.

Each processor core 201 is connected to an interconnect 207. The particular construction of the interconnect 207 may vary depending upon the architecture of the processor unit 201. With some processor cores 201, such as the Cell microprocessor created by Sony Corporation, Toshiba Corporation and IBM Corporation, the interconnect 207 may be implemented as an interconnect bus. With other processor units 201, however, such as the Opteron™ and Athlon™ dual-core processors available from Advanced Micro Devices of Sunnyvale, Calif., the interconnect 207 may be implemented as a system request interface device. In any case, the processor cores 201 communicate through the interconnect 207 with an input/output interface 209 and a memory controller 211. The input/output interface 209 provides a communication interface between the processor unit 201 and the bus 115. Similarly, the memory controller 211 controls the exchange of information between the processor unit 201 and the system memory 107. With some implementations of the invention, the processor units 201 may include additional components, such as a high-level cache memory accessible shared by the processor cores 201.

It should be appreciated that, with some implementations, a multi-core processor unit 111 can be used in lieu of multiple, separate processor units 111. For example, rather than employing six separate processor units 111, an alternate implementation of the invention may employ a single processor unit 111 having six cores, two multi-core processor units each having three cores, a multi-core processor unit 111 with four cores together with two separate single-core processor units 111, etc.

Returning now to FIG. 1, the interface device 113 allows the master computer 103 to communicate with the servant computers 117A, 117B, 117C . . . 117c through a communication interface. The communication interface may be any suitable type of interface including, for example, a conventional wired network connection or an optically transmissive wired network connection. The communication interface may also be a wireless connection, such as a wireless optical connection, a radio frequency connection, an infrared connection, or even an acoustic connection. The interface device 113 translates data and control signals from the master computer 103 and each of the servant computers 117 into network messages according to one or more communication protocols, such as the transmission control protocol (TCP), the user datagram protocol (UDP), and the Internet protocol (IP). These and other conventional communication protocols are well known in the art, and thus will not be discussed here in more detail.

Each servant computer 117 may include a memory 119, a processor unit 121, an interface device 123, and, optionally, one more input/output devices 125 connected together by a system bus 127. As with the master computer 103, the optional input/output devices 125 for the servant computers 117 may include any conventional input or output devices, such as keyboards, pointing devices, microphones, display monitors, speakers, and printers. Similarly, the processor units 121 may be any type of conventional or custom-manufactured programmable processor device. For example, one or more of the processor units 121 may be commercially generic programmable microprocessors, such as Intel® Pentium® or Xeon™ microprocessors, Advanced Micro Devices Athlon™ microprocessors or Motorola 68K/Coldfire® microprocessors. Alternately, one or more of the processor units 121 may be custom-manufactured processors, such as microprocessors designed to optimally perform specific types of mathematical operations. Still further, one or more of the processor units 121 may have more than one core, as described with reference to FIG. 2 above. For example, with some implementations of the invention, one or more of the processor units 121 may be a Cell processor. The memory 119 then may be implemented using any combination of the computer readable media discussed above. Like the interface device 113, the interface devices 123 allow the servant computers 117 to communicate with the master computer 103 over the communication interface.

In the illustrated example, the master computer 103 is a multi-processor unit computer with multiple processor units 111, while each servant computer 117 has a single processor unit 121. It should be noted, however, that alternate implementations of the invention may employ a master computer having single processor unit 111. Further, one or more of the servant computers 117 may have multiple processor units 121, depending upon their intended use, as previously discussed. Also, while only a single interface device 113 or 123 is illustrated for both the master computer 103 and the servant computers, it should be noted that, with alternate embodiments of the invention, either the computer 103, one or more of the servant computers 117, or some combination of both may use two or more different interface devices 113 or 123 for communicating over multiple communication interfaces.

With various examples of the invention, the master computer 103 may be connected to one or more external data storage devices. These external data storage devices may be implemented using any combination of computer readable media that can be accessed by the master computer 103. The computer readable media may include, for example, microcircuit memory devices such as read-write memory (RAM), read-only memory (ROM), electronically erasable and programmable read-only memory (EEPROM) or flash memory microcircuit devices, CD-ROM disks, digital video disks (DVD), or other optical storage devices. The computer readable media may also include magnetic cassettes, magnetic tapes, magnetic disks or other magnetic storage devices, punched media, holographic storage devices, or any other medium that can be used to store desired information. According to some implementations of the invention, one or more of the servant computers 117 may alternately or additionally be connected to one or more external data storage devices. Typically, these external data storage devices will include data storage devices that also are connected to the master computer 103, but they also may be different from any data storage devices accessible by the master computer 103.

It also should be appreciated that the description of the computer network illustrated in FIG. 1 and FIG. 2 is provided as an example only, and it not intended to suggest any limitation as to the scope of use or functionality of alternate embodiments of the invention.

### Optical Proximity Correction

In a photolithographic process, as explained above, electromagnetic radiation is transmitted through selectively transparent areas of a mask. The radiation passing through these transparent areas then irradiates desired portions of a layer of photoresistive material on a semiconductor substrate. The mask in turn is created from layout design data describing the geometric features that should be manufactured on the semiconductor substrate in order to create the desired circuit. For example, if a transistor should have a rectangular gate region, then the layout design data will include a rectangle defining that gate region. This rectangle in the layout design data is then implemented in a mask for creating the rectangular gate region.

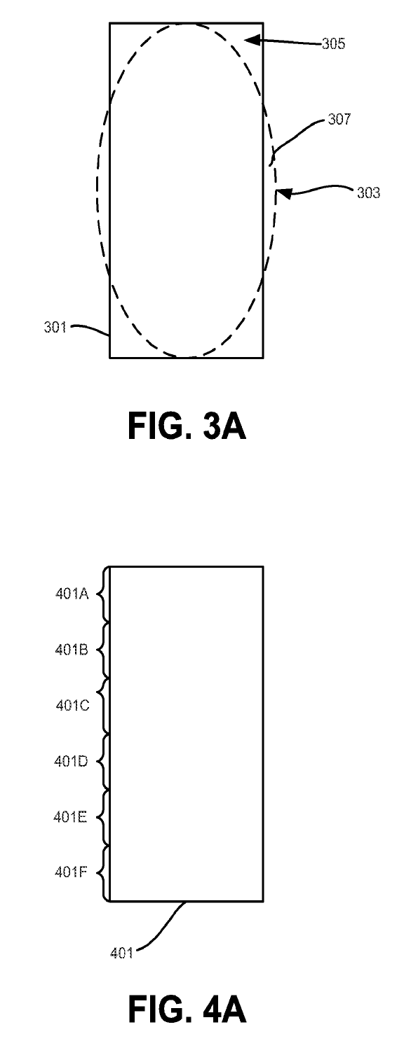

During a photolithographic process, however, optical effects will prevent the shapes defined by the mask from being faithfully imaged onto the substrate. Diffractive effects, for example, may distort the image produced by a mask. Moreover, these distortions become more pronounced as the images produced by the mask become smaller relative to the wavelength of radiation used in the photolithographic process. Thus, the rectangular mask feature 301 illustrated in FIG. 3 may produce only the image 303. As seen in this figure, the image 303 is substantially narrower in the corners (e.g., corner 305) than the ideal rectangular shape intended by the mask feature 301. Likewise, the image 303 may have areas (e.g., 307) that extend beyond the ideal rectangular shape intended by the mask feature 301. Often the intended shape or feature is referred to as the target shape, or the target image, and typically corresponds to the mask feature 301. Additionally, the image created by employing the mask in a photolithographic process is often referred to as the printed image.

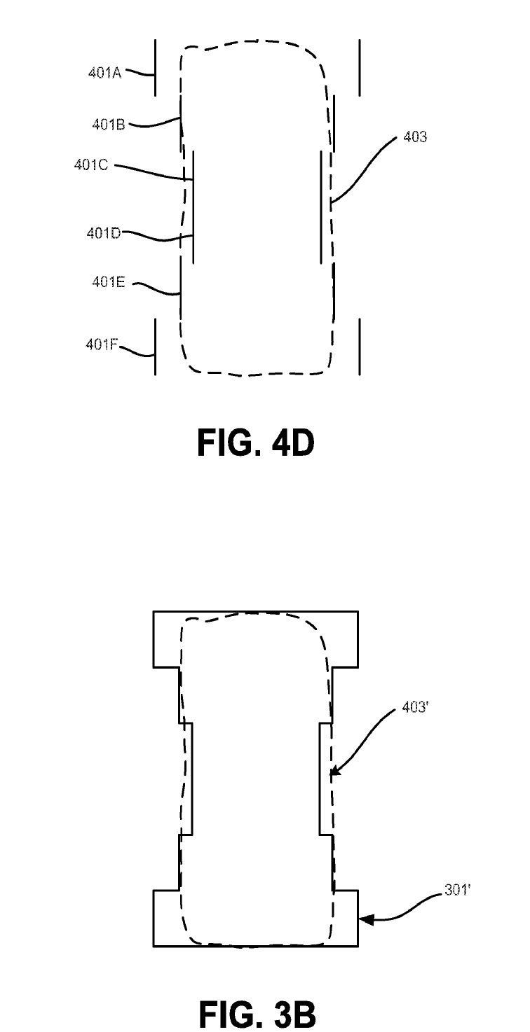

To correct for these optical distortions, many circuit designers will attempt to modify the layout design data to enhance the resolution of the images that will be produced by the resulting mask during the photolithographic process. Thus, some designers will employ an optical proximity correction (OPC) process on the layout design data, in an effort to better control the amplitude of the radiation transmitted by the mask at specific locations. In a conventional optical proximity correction process, the edges of the geometric elements in the design are fragmented. For example, as shown in FIG. 4A, an edge of the geometric element 401 used to create the mask feature 301 may be fragmented into edge fragments 401A-401F. The size of the edge fragments in a given layout design depends upon the optical proximity correction process parameters, often referred to as the optical proximity correction recipe. The “recipe” specifies, e.g., the size of the edge fragments. Accordingly, not all edges within a layout design are fragmented in every optical proximity correction process.

The optical proximity correction process also simulates the printed image. That is, the photolithographic process is simulated in order to produce a simulated printed image, such as the example image 303 shown in FIG. 3. This simulated image is compared to the target image. Typically, this comparison is done at each edge fragment. For example, as shown in FIG. 4B, the target image is a distance d1 away from the simulated printed image at the edge fragment 401A, the target image is a distance d2 away from the simulated printed image at the edge fragment 401C, while the target image intersects the simulated printed image at the edge fragment 401B. The distances between the target image and the simulated printed image are often referred to as the edge placement error (EPE). Accordingly, in most conventional optical proximity correction process each edge fragment or unfragmented edge has an associated edge placement error.

Next, the edge fragments are individually moved in order to improve the resolution of the simulated printed image for the resulting mask. For example, as shown in FIG. 4C, the edge fragment 401A is displaced in a direction away from the geometric element 401, in an effort to widen the corresponding portion of the image that would be produced by the resulting mask. Similarly, the edge fragment 401C is displaced in a direction toward from the geometric element 401, in an effort to narrow the corresponding portion of the image that would produced by the resulting mask. Next, the image that would be produced by a mask using the displaced edge fragments is simulated, and the new simulated image is compared with the target image, and the edge placement errors for each edge fragment are computed.

This process of moving the edge fragments, simulating the image that would be produced using the moved edge fragments, and comparing the simulated image to the target image may be repeated a number of times. Each cycle of moving edge fragments and comparing the new simulated image to target image is referred to as an iteration of the optical proximity correction process. Typically, edge fragments moved during an given iteration, and the distance the edge fragments are displaced is determined based upon the edge placement error. For example, an optical proximity correction process may move the edge fragments some factor of the edge placement error away from the simulated printed image. Additionally, each edge fragment could be displaced the same distance during a given iteration. The specific parameters than control edge movement is dependant upon the tool used to implement the optical proximity correction process and the optical proximity correction process recipe.

Typically, these steps will be repeated until the simulated image is sufficiently similar to the target image (e.g., both d1 and d2 are smaller than a threshold value), or until it is determined that the displacements of the edge fragments already have converged on locations where no further movement of the edge fragments will improve the simulated image, as shown in FIG. 4D. Once the final positions of the edge fragments are determined in the layout design data, as shown in FIG. 4D, a modified mask feature 301′ can be created from the corrected layout design data. As shown in FIG. 3B, the image 303′ produced by the modified mask feature 301′ should more closely correspond to the target image.

### Pre-OPC Layout Editing Tool

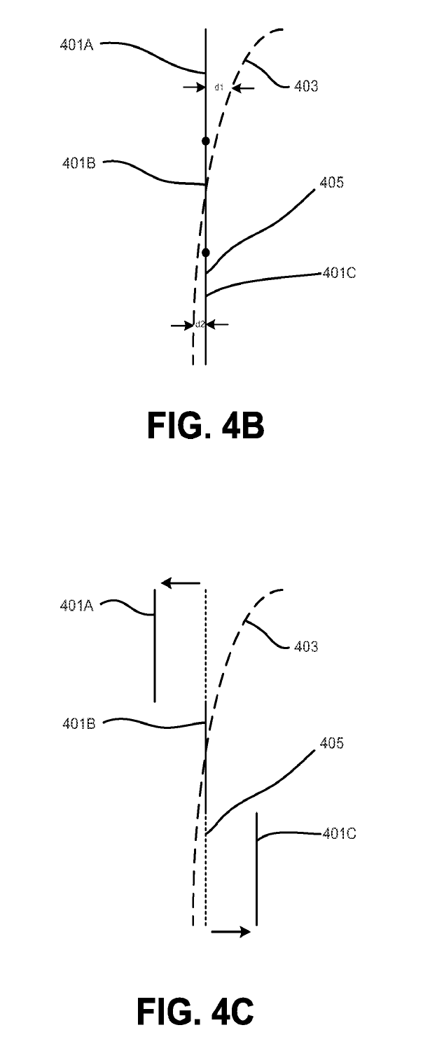

FIG. 5 illustrates an example of a pre-optical proximity correction layout editing tool 501 that may be implemented according to various embodiments of the invention. As seen in this figure, the layout editing tool 501 includes a fault identification module 503, a rule check limit determination module 505, and a design modification module 507. As also shown in this figure, various implementations of the layout editing tool 501 may cooperate with (or incorporate in whole or part) an optical proximity correction module 509 and a design database 511.

As will be discussed in more detail below, the optical proximity correction module 509 will perform an optical proximity correction process on a layout design stored in the design database 511. Next, the fault determination module 503 will identify any faults that were generated in the results of the optical proximity correction process, such as bridging or pinching faults. For each fault, the rule check limit determination module 505 will determine if the fault corresponds to one or more geometric element edge fragments that were constrained by a mask rule during the optical proximity correction process. If a fault does correspond to one or more geometric element edge fragments that were constrained by a mask rule during the optical proximity correction process, then the design modification module 507 will edit the layout design to overcome the mask rule that constrained those geometric element edge fragments. The edited design data is then returned to the optical proximity correction module 509 for another optical proximity correction process. With this subsequent optical proximity correction process, however, the simulated image generated using the edited layout design data is compared with the target image for the original layout design data rather than the edited layout design data. This prevents the subsequent optical proximity correction operation from undoing the improved optical benefits provided by the edits to the original layout design data.

As previously noted, various examples of the invention may be embodied by a multiprocessor computing system, such as the multiprocessor computing system 101 illustrated in FIG. 1. Accordingly, one or more components of each of the fault identification module 503, the rule check limit determination module 505, the design modification module 507, and the optical proximity correction module 509 may be implemented using one or more processors in a multiprocessor computing system's master computer, such as the master computer 103, one or more servant computers in a multiprocessor computing system, such as the servant computers 117, or some combination of both. It also should be appreciated that, while the fault identification module 503, the rule check limit determination module 505, the design modification module 507, and the optical proximity correction module 509 are shown as separate units in FIG. 5, a single servant computer (or a single processor within a master computer) may be used to implement two or more of these modules at different times, or components of two or more of these modules at different times. Also, various examples of the invention may be embodied by software-executable instructions, stored on a computer-readable medium, for instructing a computing system to implement one or more components of each of the fault identification module 503, the rule check limit determination module 505, the design modification module 507, and the optical proximity correction module 509.

It should be appreciated that, as used herein, the term “design” is intended to encompass data describing an entire microdevice, such as an integrated circuit device or micro-electromechanical system (MEMS) device. This term also is intended to encompass a smaller group of data describing one or more components of an entire microdevice, however, such as a layer of an integrated circuit device, or even a portion of a layer of an integrated circuit device. Still further, the term “design” also is intended to encompass data describing more than one microdevice, such as data to be used to create a mask or reticle for simultaneously forming multiple microdevices on a single wafer. The layout design data may be in any desired format, such as, for example, the Graphic Data System II (GDSII) data format or the Open Artwork System Interchange Standard (OASIS) data format proposed by Semiconductor Equipment and Materials International (SEMI). Other formats include an open source format named Open Access, Milkyway by Synopsys, Inc., and EDDM by Mentor Graphics, Inc.

### Layout Editing

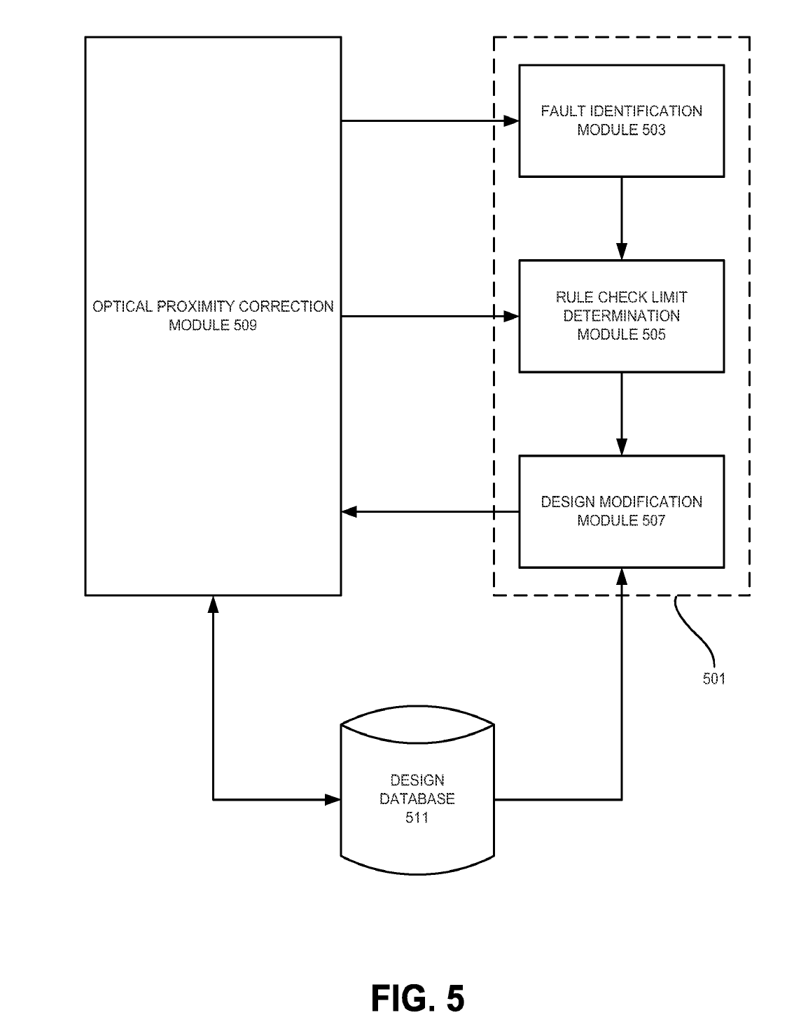

FIG. 6 illustrates a flowchart describing methods of editing layout design data according to various embodiments of the invention. For purposes of explanation, the various methods encompassed in FIG. 6 will be described herein as being implemented by the layout editing tool 501 shown in FIG. 5. It will be appreciated by those of ordinary skill in the art, however, that various methods of the invention encompassed by the flowchart of FIG. 6 may performed by layout editing tools different from the layout editing tool 501 shown in FIG. 5. Similarly, it will be appreciated by those of ordinary skill in the art that the layout editing tool 501 shown in FIG. 5 may be used to perform methods according to various embodiments of the invention different from those encompassed by the flowchart of FIG. 6. Also, it should be appreciated that various embodiments of the invention may be implemented by a programmable computer (or special purpose computer) performing the operations described with respect to the flowchart shown in FIG. 6 and discussed herein. Still further, various embodiments of the invention may be implemented by software instructions, stored on a computer-readable medium, for instructing a programmable computer (or special purpose computer) to perform the operations described with respect to the flowchart shown in FIG. 6 and discussed herein

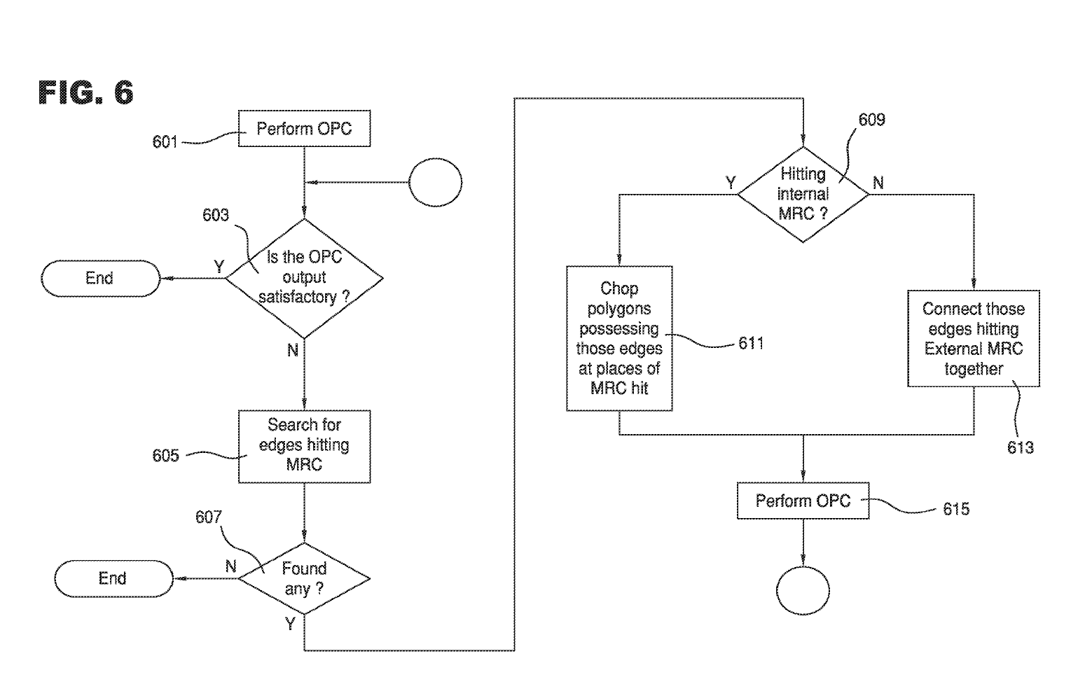

Initially, in operation 601, the optical proximity correction module 509 performs an optical proximity correction operation on layout design data. The optical proximity correction operation may employ any optical proximity correction process, such as the conventional type of optical proximity correction process described in detail above. As previously noted, the optical proximity correction operation will create a simulated image. FIG. 7A illustrates an example of results 701 that might be generated by an optical proximity correction process. The results 701 include a target image 703 corresponding to layout design, and a simulated image 705 generated by an optical proximity correction process.

Next, in operation 603, the fault identification module 503 analyzes the results of the optical proximity correction operation to identify faults in the results. If there are no faults in the optical proximity correction results, then the process ends. As will be appreciated by those of ordinary skill in the art, however, the optical proximity correction process results may include a variety of faults of different types, such as bridging faults and pinching faults. For example, the optical proximity correction process results 701 contain faults in two regions 707A and 707B, as shown in FIG. 7B. As seen in this figure, a portion of the simulated image 705 corresponding to the target geometric element 709 encroaches too closely to a portion of the simulated image 705 corresponding to the target geometric element 711, creating the fault in region 707A. (Each portion extends well beyond the perimeter of its corresponding target geometric element.) A portion of the simulated image 705 corresponding to the target geometric element 711 then encroaches too closely to a portion of the simulated image 705 corresponding to the target geometric element 713, creating the fault in region 707B.

It should be appreciated that the fault identification module 503 may be implemented using any conventional electronic design automation fault identification tool, such as a fault identification tool in the CALIBRE® family of electronic design automation tools available from Mentor Graphics Corporation of Wilsonville, Oreg. Also, while the layout editing tool 501 shown in FIG. 5 includes the fault identification module 503, it should be appreciated that various implementations of the invention may omit the fault identification module 503 from the layout editing tool 501. For example, some implementations of a layout editing tool according to various embodiments of the invention may employ an external fault identification tool to identify faults in optical proximity correction process results. The layout editing tool can then import and use the fault information created by the external fault identification tool.

As previously noted, various implementations of the invention will attempt to edit original layout design to address faults surviving the optical proximity correction operation 601. In the example shown in FIG. 7B, the faults in regions 707 result from an insufficient amount of light passing through the surrounding regions (identified by the ellipse 715). Accordingly, various implementations of the invention will attempt address the faults in regions 707 by editing the original layout design data to allow more light to pass through the surrounding region. With various implementations of the invention, the original layout design data will be the initial layout design data provided to the optical proximity correction process (i.e., pre-optical proximity correction layout design data). With still other implementations of the invention, however, the original layout design data will be the layout design data produced by the optical proximity correction process.

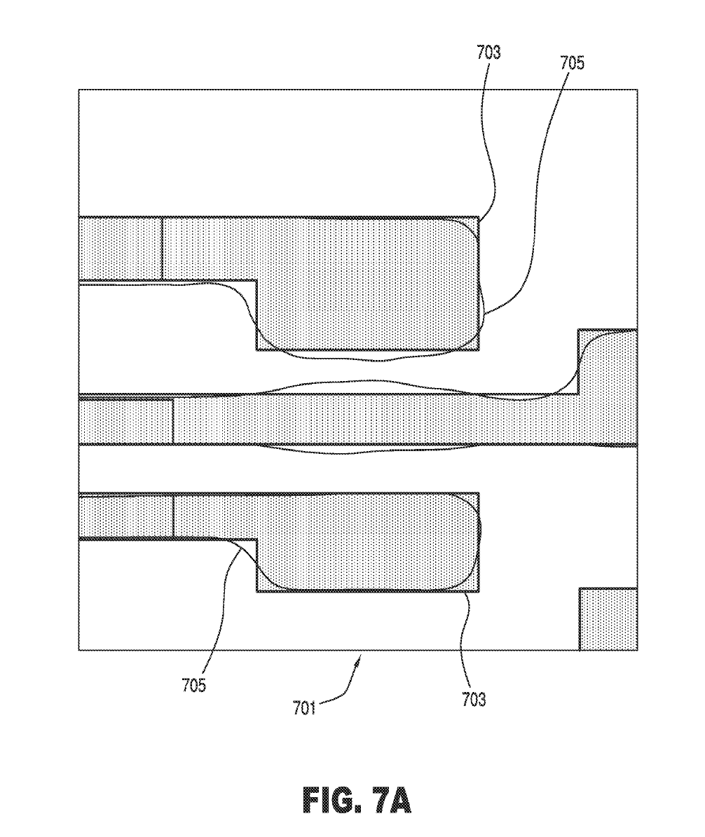

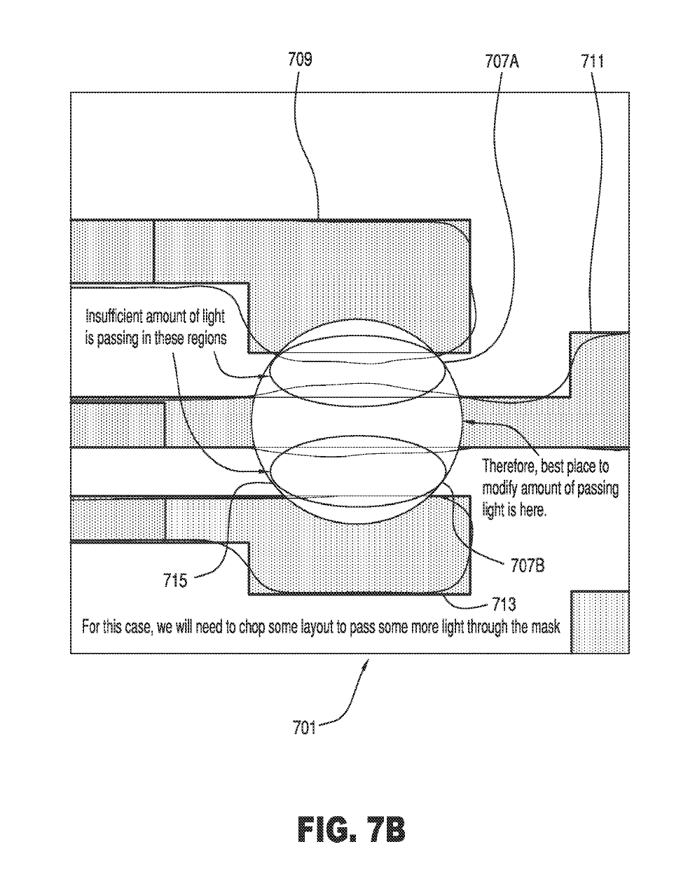

FIG. 8 illustrates a cross section of a mask portion 801 corresponding to the target geometric element 711 along the cut line B shown in FIG. 7C. FIGS. 9A-9C then illustrate the amount of light incident on a substrate along section lines A, B, and C shown in FIG. 7C, respectively. As seen in FIG. 9B, the chrome in the mask portion 801 blocks the incident light along the section line B. Because the intensity of the incident light along the section line B is below the threshold amount to affect the photoresistive material during a lithographic manufacturing process, the image of the mask portion 801 is printed on the substrate (e.g., a silicon wafer). As seen from FIG. 9A, the intensity of the incident light drops below the threshold amount around the middle of the mask portion 801. This drop in intensity causes an unintended image to be printed on the substrate during the lithographic process, creating the fault in area 707A. Similarly, as seen in FIG. 9C the intensity of the incident light drops below the threshold amount around the middle of the mask portion 801, creating the faults in area 707B.

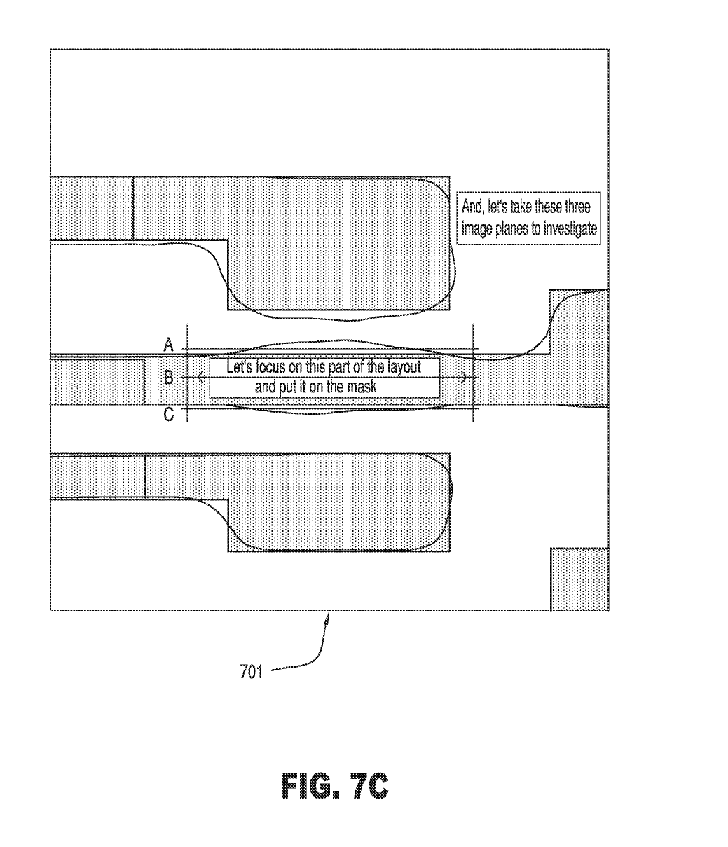

In order to correct these faults, various implementations of the invention will edit the original layout design data so that the corresponding mask portion will allow more light to reach the substrate. For example, some implementations of the invention may delete a section of geometric element 711 in the layout design corresponding to the lowest intensity of the incident light along section lines A and C. This produces a gap 1001 in the mask portion 801, as shown in FIG. 10.

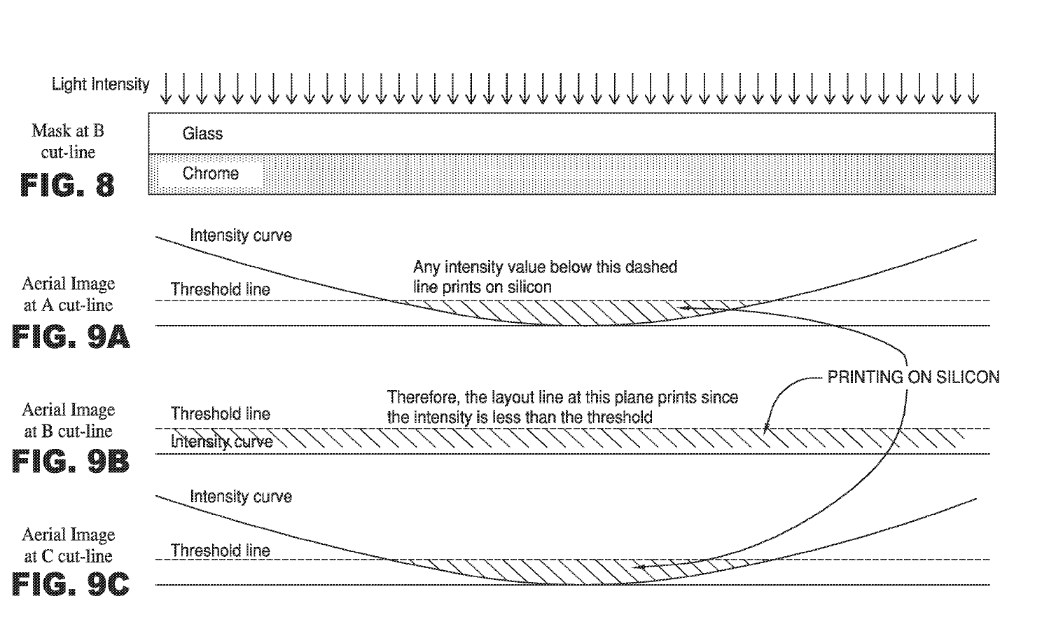

FIGS. 11A-11C illustrate the amount of light incident on a substrate along section lines A, B, and C, respectively, with the gap 1001. As seen in FIG. 11B, even with the gap 1001 in the mask portion 801, the intensity of the incident light along section line B is still below the threshold value. Accordingly, an image corresponding to the original geometric element 711 is printed on the substrate during a photolithographic manufacturing process. As seen in FIGS. 11A and 11C, however, the intensity of incident light along sections lines A and C is substantially increased.

Even with the increase in the intensity of incident light along section line A, however, the intensity of some incident light still falls below the threshold value at two locations. Similarly, even with the increase in the intensity of incident light along section line C, the intensity of some incident light still falls below the threshold value at two locations. As will be appreciated by those of ordinary skill in the art, these low-intensity regions might produce four smaller faults during a lithographic manufacturing process. Accordingly, various implementations of the invention will make additional edits to the original layout design data so that the corresponding mask portion 801 will allow still more light to reach the substrate.

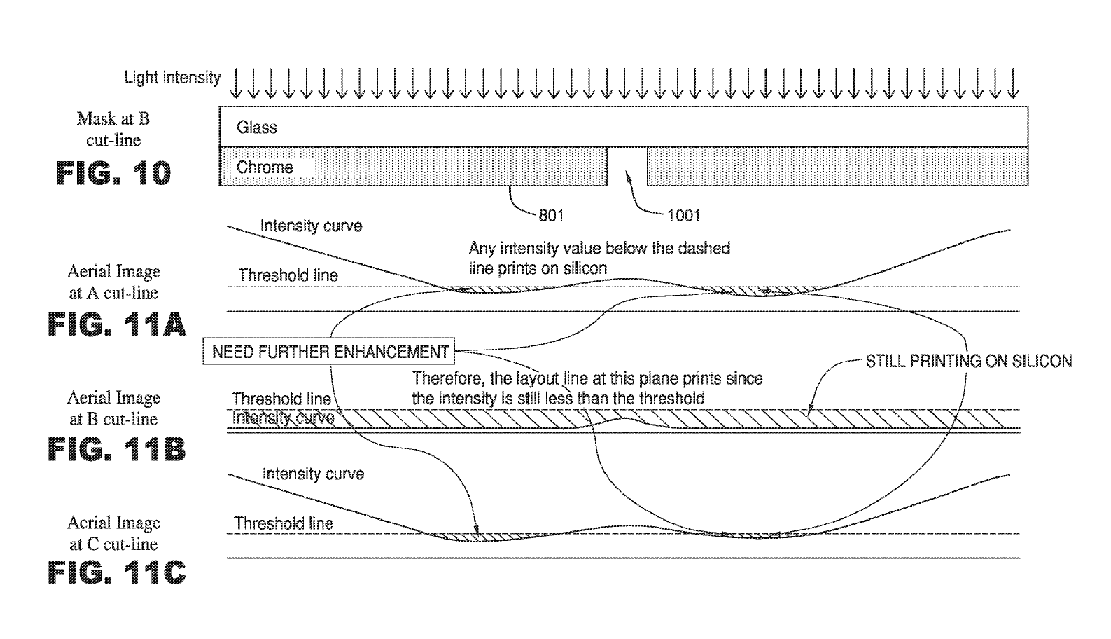

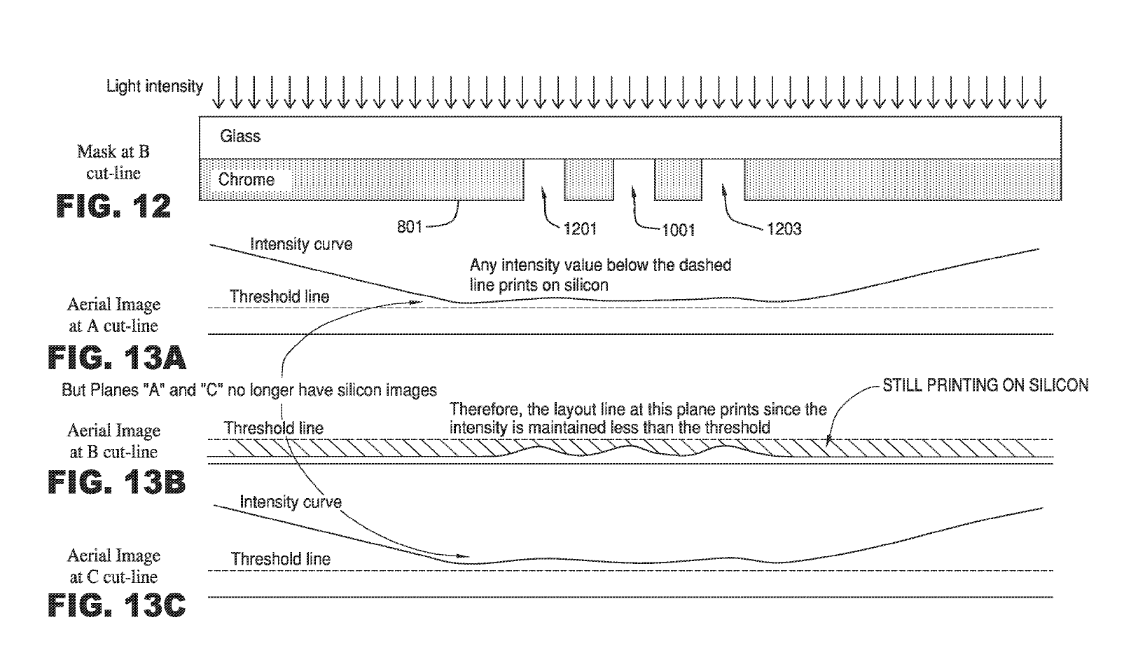

For example, some implementations of the invention may delete two more sections of geometric element 711 in the layout design corresponding to the two lowest intensity regions of the incident light along section lines A and C. This produces gaps 1201 and 1203 in the mask portion 801, as shown in FIG. 12. FIGS. 13A-13C illustrate the amount of light incident on a substrate along section lines A, B, and C, respectively, with the gaps 1001, 1201 and 1203 present. As seen in FIG. 13B, even with the gaps 1001, 1201 and 1203 in the mask portion 801, the intensity of the incident light along section line B is still below the threshold value. Accordingly, an image corresponding to the original geometric element 711 is printed on the substrate during a photolithographic manufacturing process. As seen in FIGS. 13A and 13C, however, the intensity of incident light along sections lines A and C is increased so that no image is printed along either of these sections lines. Thus, editing the layout design data to create the gaps 1001, 1201 and 1203 removes the faults in the areas 707.

With various implementations of the invention, the edits to the layout design data can be made using any desired technique, such as an analysis of incident light intensity like that described above with respect to FIGS. 7C-13C. Still other implementations of the invention may alternately or additionally employ other techniques for determining the edits to be made to the layout design data. For example, some implementations of the invention, such as the layout editing tool 501, may edit the original layout design data based upon conflicts between the optical proximity correction process and mask rules that constrain the movements of geometric element edge fragments during the optical proximity correction process.

As will be appreciated by those of ordinary skill in the art, movement of a geometric element edge fragment by an optical proximity correction process may “hit” (i.e., be constrained by) a minimum width mask rule. That is, a minimum width mask rule may prevent a geometric element edge fragment on one side of a geometric element from being moved too close to the corresponding geometric element edge fragment on the opposite side of the geometric element, in order to maintain a minimum width for the geometric element. In other situations, movement of a geometric element edge fragment by an optical proximity correction process may “hit” (i.e., be constrained by) a spacing mask rule. That is, a spacing mask rule may prevent the optical proximity correction process from moving the geometric element edge fragment too close to another geometric element.

Accordingly, if one or more faults are identified by the fault identification module 503 in operation 603, then the rule check limit determination module 505 analyzes geometric element edge fragments in the layout design to determine if any were constrained by a mask rule in operation 605. With some implementations of the invention, the rule check limit determination module 505 may consider only those geometric element edge fragments that may be associated with an indentified fault. With still other implementations of the invention, however, the rule check limit determination module 505 may determine if any geometric element edge fragment in the layout design hit a mask rule.

In operation 607, the rule check limit determination module 505 determines if any of the considered geometric element edge fragments hit a mask rule during the optical proximity correction process. If none did, then the process ends. If, however, the rule check limit determination module 505 determines that one or more of the considered geometric element edge fragments did hit a mask rule during optical proximity correction, then the process continues to operation 609. In operation 609, for each such geometric element edge fragment, the rule check limit determination module 505 (or, with some implementations of the invention, the design modification module 507) identifies what type of mask rule the geometric element edge fragment hit.

As previously noted, in some situations movement of a geometric element edge fragment by an optical proximity correction process may be constrained by a minimum (internal) width mask rule. That is, a minimum width mask rule may prevent a geometric element edge fragment on one side of a geometric element from being moved too close to the corresponding geometric element edge fragment on the opposite side of the geometric element, in order to maintain a minimum width for the geometric element. If this occurs, then the design modification module 507 will edit the layout design data in operation 611 to overcome this internal constraint. More particularly, the design modification module 507 will delete the portion of the geometric element corresponding to the opposing geometric element edge fragments, leaving a gap in the geometric element. With various implementations of the invention, the gap will have the minimum external mask rule dimension.

In other situations, movement of a geometric element edge fragment by an optical proximity correction process may “hit” (i.e., be constrained by) a spacing (external) mask rule. That is, a spacing mask rule may prevent the optical proximity correction process from moving the geometric element edge fragment too close to another geometric element. If this occurs, then the design modification module 507 will edit the layout design data in operation 613 to overcome this external constraint. More particularly, the design modification module 507 will edit the layout design to add an area connecting the two geometric elements together. In other words, the design modification module 507 effectively extends the previously-constrained geometric element edge fragment beyond the space width mask rule to the adjacent geometric element. With various implementations of the invention, the connector area will have the minimum width allowed by the mask rules, so that the edited layout design will include a bridge between the two geometric elements having the minimum internal mask rule dimension. The minimum dimensions for gaps and connectors are employed by various embodiments of the invention in order not to reverse a bridging problem into a pinching problem in situations where a minimum width mask rule is hit, and to avoid reversing a pinching problem into a bridging problem in situations where a minimum spacing mask rule is hit.

Once the design modification module 507 has finished editing the layout design data, then the optical proximity correction module 509 may perform another optical proximity correction process in operation 615 using the edited layout design data. As will be appreciated by those of ordinary skill in the art, this subsequent optical proximity correction process will be adjusted so as not to undo (and, further, to take advantage of) the beneficial optical effects of the edits made by the design modification module 507.

For example, with some implementations of the invention, the optical proximity correction module 509 will create a simulated image using the edited layout design data, but compare that simulated image with the target image for the original layout design. Also, in order to properly move the remaining geometric element edge fragments, with various implementations of the invention the optical proximity correction process will combine the edge placement errors (EPE) for edited geometric element edge fragments with the edge placement errors for adjacent original geometric element edge fragments (i.e., geometric element edge fragments that have not been edited).

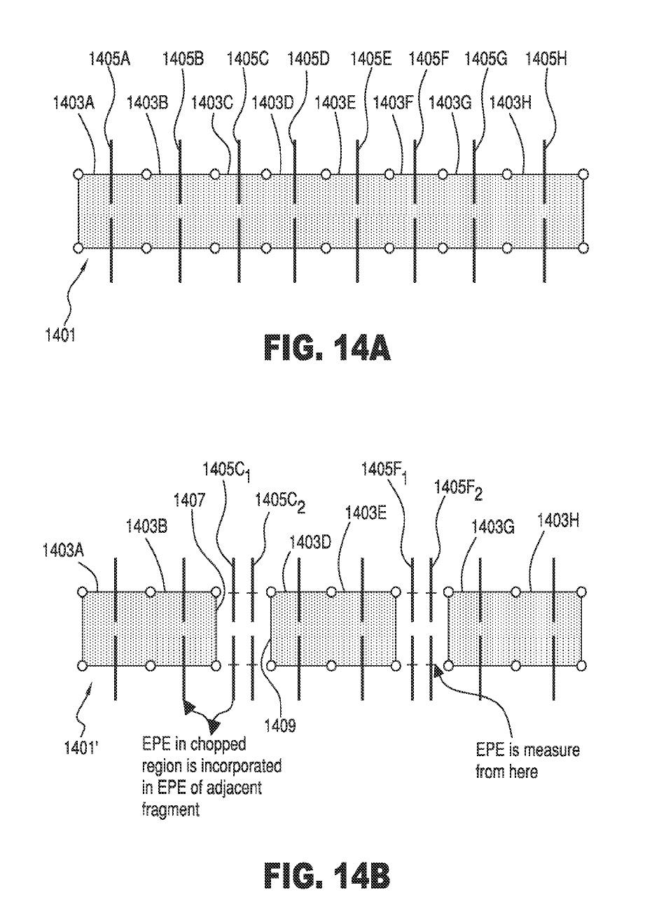

For example, FIG. 14A illustrates an original geometric element 1401 with edge fragments 1403A-1403H. During a conventional optical proximity correction process, the edge placement error for each geometric element edge fragment is measured along a line 1405 perpendicular to (and, typically, bisecting) the corresponding geometric element edge fragment 1403. FIG. 14B illustrates an edited geometric element 1401′ that may be produced after the original geometric element 1401 has been edited according to various embodiments of the invention. In this example, the portions of the geometric element 1401 corresponding to the edge fragments 1403C and 1403F have been deleted. With various implementations of the invention, two edge placement errors may be measured for each deleted edge fragment, with each edge placement error being measured along a different line 1405 as shown in FIG. 14B.

In this arrangement, for example, a first edge placement error can be measured along line 1405C₁ (from the image simulated from the edited layout data to the position of the edge 1403C in the original layout data). A second edge placement error can similarly be measured along line 1405C₂. As seen in this figure, the line 1405C₁ is closer to adjacent edge fragment 1403B, while the line 1405C₂ is closer to the adjacent edge fragment 1403D. With various examples of the invention, the edge placement error measured along line 1405C₁ can then be combined with the edge placement error measured for the adjacent edge fragment 1403B. The combined edge placement error can then be used by the optical proximity correction module 509 to reposition the edge fragment 1403B to improve the expected fidelity of the edited layout design. Similarly, the edge placement error measured along line 1405C₂ can be combined with the edge placement error measured for the adjacent edge fragment 1403D, and the combined edge placement error used to reposition the edge fragment 1403D.

With various embodiments of the invention, the edge placement errors for edited geometric element edge fragments can be combined with the edge placement errors for original geometric element edge fragments in any desired manner. For example, some implementations of the invention may use a biased or weighted average calculation to combine edge placement errors. Also, it should be appreciated that various implementations of the invention could determine a single edge placement error for an edited geometric element edge fragment (measured along, e.g., a line bisecting the corresponding original geometric element edge fragment). This single edge placement error could then be combined with the edge placement errors for both adjacent original geometric element edge fragments. Still further, various embodiments of the invention may determine three or more edge placement errors for an edited geometric element edge fragment, and combine those edge placement errors with the edge placement errors of further removed original geometric element edge fragments.

With some implementations of the invention, the geometric element edge fragments facing edits made by the design modification module 507 will not be repositioned during a subsequent optical proximity correction process. For example, with some implementations of the invention, the geometric element edge fragments 1407 and 1409 would not be moved relative to each other in a subsequent optical proximity correction process. Still other implementations of the invention, however, may allow movement of geometric element edge fragments facing edits made by the design modification module 507, such as geometric element edge fragments 1407 and 1409, to improve the expected fidelity of the edited layout design.

It should be appreciated that, with some implementations of the invention, the subsequent optical proximity correction process is performed locally on a clipped layout window around the edited region, to test its output validity. If the edited region of the layout design shows edge placement errors within specified tolerances, an optional process window check may also be performed on the edited region to test its validity through the available process window. Once the validity of edited layout design regions is verified, the edited layout design region is integrated into the layout design. It also should be appreciated that, with various implementations of the invention, edited layout design data (e.g., layout design data incorporating regions that have been edited according to various examples of the invention) may be subjected to one or more further iterations of the optical proximity correction/editing/subsequent optical proximity correction process described in detail above.

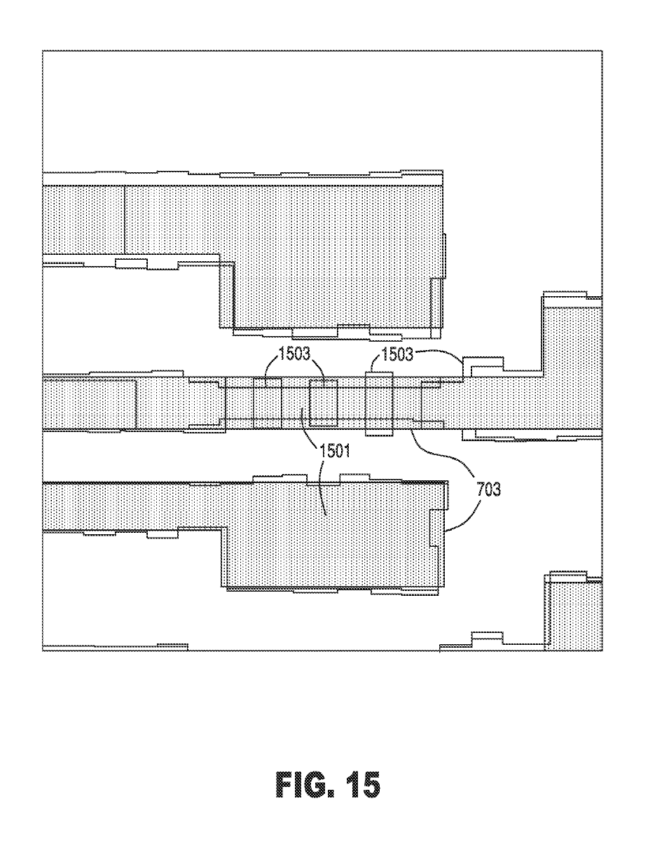

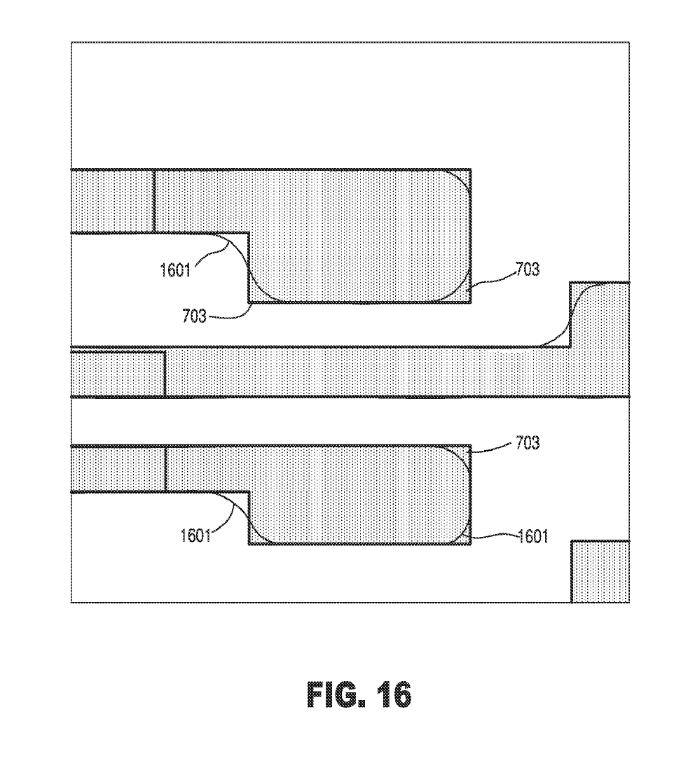

FIG. 15 illustrates layout design data corresponding to the original layout design data example shown in FIG. 7. More particularly, this figure shows the target image 703 corresponding to an original layout design. It also shows layout design data 1501 that has been modified by a conventional optical proximity correction process, and edited layout design data 1503 that has been edited and subjected to a subsequent optical proximity correction process according to an embodiment of the invention. As seen in this figure, the layout design data 1503 created by an embodiment of the invention includes four gaps that are not found in the layout design data 1501 produced by a conventional optical proximity correction process. FIG. 16 then illustrates the target image 703 and the image 1601 produced by the edited and processed layout design data 1503. As seen in this figure, the simulated image 1601 produced by the edited and processed layout design data 1503 is very close to the target image 703.

### CONCLUSION

While the invention has been described with respect to specific examples including presently preferred modes of carrying out the invention, those skilled in the art will appreciate that there are numerous variations and permutations of the above described systems and techniques that fall within the spirit and scope of the invention as set forth in the appended claims. For example, while specific terminology has been employed above to refer to electronic design automation processes, it should be appreciated that various examples of the invention may be implemented using any desired combination of electronic design automation processes.

What is claimed is:

1. A method of transforming layout design data, comprising:
identifying a fault in optical proximity correction results corresponding to a first geometric element in original layout design data; and
editing the original layout design data to delete a portion of a first geometric element or add a connector connecting the first geometric element to a second geometric element in the original layout design data.

2. The method recited in claim 1, further comprising performing a subsequent optical proximity correction process on the edited layout design data.

3. The method recited in claim 2, wherein the subsequent optical proximity correction process
generates a simulated image from the edited layout design data, and
employs a target image for the original layout design data.

4. A computer readable medium storing instructions for instructing a computing system to perform the method recited in claim 1.

5. A layout design editing tool, comprising:
a fault identification module configured to identify a fault in optical proximity correction results produced by performing an optical proximity correction process;
a rule check limit determination module configured to determine if the fault is associated with an edge fragment of a first geometric element in original layout design data that was constrained by a mask rule during the optical proximity correction process producing; and
a design modification module configured to editing the original layout design data to delete a portion of a first geometric element or add a connector connecting the first geometric element to a second geometric element in the original layout design data in response to a determination made by the rule check limit determination module.
